(19) United States
(12) Patent Application Publication
(10) Pub. No.: US 2021/0264461 A1
(43) Pub. Date: Aug. 26, 2021

(54) SYSTEM AND METHOD FOR MANAGING BUSINESS LOYALTY AND REWARD PROGRAMS

(71) Applicant: Markaaz, Inc., New York, NY (US)

(72) Inventor: Hany A. Fam, Poole (GB)

(21) Appl. No.: 17/181,645

(22) Filed: Feb. 22, 2021

Related U.S. Application Data
(60) Provisional application No. 62/980,037, filed on Feb. 21, 2020.

(51) Int. Cl. G06Q 30/02; G06Q 40/02; G06Q 20/22

(52) U.S. Cl. CPC G06Q 30/0227; G06Q 20/227; G06Q 40/02

(57) ABSTRACT

A system for business loyalty programs comprising a loyalty platform comprising a plurality of available payment methods and a payment engine configured to review the plurality of available payment methods. The payment engine identifies desirable payment options from the available payment methods.

### CROSS REFERENCE TO RELATED APPLICATION

The present application is a nonprovisional patent application, which claims the priority benefit of U.S. Application Ser. No. 62/980,037, filed Feb. 21, 2020, the text and drawings of which are hereby incorporated in its entirety.

### TECHNICAL FIELD

This disclosure relates generally to the field of electronic commerce technology. In particular, it relates to a system and method for managing business loyalty and reward programs.

### BACKGROUND

The use of loyalty and rewards programs is now widespread. Sellers often offer certain rewards to repeat customers in order to both thank the customer for continued loyalty and to encourage those customers to return for additional purchases. These rewards may come in a variety of forms. A coffee shop may offer customers a free cup of coffee after the purchase of a certain number of cups of coffee. An airline may offer a certain number of free air miles for each mile flown. Some of these rewards programs may allow customers to build up reward points which they can use on a number of sellers' goods or services.

The average American household belongs to 29 loyalty programs but struggles to redeem earned rewards, leading users to miss out on $16 billion of value every year. Approximately 72% of those US loyalty programs are generated from banks and credit card issuers. An online survey of 6,000 Canadians finds that loyalty program enrollment is up, but the number of programs where members are active is declining. Loyalty programs are big business in Britain, with more than 40 mainstream programs currently being offered. However, shoppers are failing to reap the benefits. Almost $6 billion worth of points are sitting unclaimed in the user's wallet. Users lose track of how many points have built up in each account and how to spend them.

Recognizing that rewards are the critical point of distinction in the cluttered loyalty and payment landscape, issuers are spending billions to try and strike a chord to make their methodology the default way to pay. Some are offering cash back, others double cash back on certain purchases, others double points at a particular category (e.g. supermarkets), others triple points (e.g. gas stations). Few individuals even try to manage the different reward opportunities to maximize the benefit to them.

At point of purchase, customers are faced with little to no way to assess their payment alternatives such as points balances, rewards, and financing alternatives. As such, users are making arbitrary and simplistic decisions on how to pay and are missing out on their best way to pay. A customer may not be able to quickly determine the most advantageous method of making the desired purchase. As a result, customers are unable to optimize their purchases.

Further, rewards points are vastly under-used. As a result, many reward balances continue to grow until a portion expires, losing all of its value. Further, existing rewards programs typically limit a customer's use of their point balance within the specific program for which they are granted. For example, a customer may have a points balance of 45,000 points, but need 50,000 points in order to purchase rewards travel. The customer's only alternative may be to save future credits and forego the purchase, even when the customer has available rewards from other sources. As a result, customers lose the value of their earned rewards at a high rate.

The presently disclosed embodiments offer improvements to these prior approaches.

### SUMMARY

The present disclosure relates to a system and method for business loyalty and reward programs. In at least one embodiment, the system for business loyalty programs comprises a loyalty platform comprising a plurality of available payment methods and a payment engine configured to review the plurality of available payment methods, wherein, the payment engine identifies a desirable payment option from the available payment methods. In an aspect of such an embodiment, the available payment methods include reward points, credit cards, debit cards, or other sources of tender. In an aspect of such an embodiment, the payment engine utilizes customer data in order determine the most desirable payment option. In an aspect of such an embodiment, the payment engine converts one of the available payment methods into another available payment method. In an aspect of such an embodiment, the most desirable payment option comprises only one available payment method. In an aspect of such an embodiment, the most desirable payment option comprises two or more available payment methods. In an aspect of such an embodiment, the payment engine selects the most desirable payment option. In an aspect of such an embodiment, the payment engine provides several alternative payment options in addition to the most desirable payment option.

In at least one embodiment of the present disclosure, the method of administering business loyalty programs comprises, initiating a transaction, comparing a plurality of available payment methods, displaying available payment methods, and completing the transaction with the most desirable payment option. In an aspect of such an embodiment, the available payment methods include reward points, credit cards, debit cards, or other sources of tender. In an aspect of such an embodiment, the payment engine utilizes customer data in order determine the most desirable payment option. In an aspect of such an embodiment, the payment engine converts one of the available payment methods into another available payment method. In an aspect of such an embodiment, wherein the most desirable payment option comprises only one available payment method. In an aspect of such an embodiment the most desirable payment option comprises two or more available payment methods. In an aspect of such an embodiment, the payment engine provides several alternative payment options in addition to the most desirable payment option.

### DESCRIPTION OF DRAWINGS

FIG. 1 is a schematic diagram of a system for business loyalty and reward programs according to an embodiment of the present disclosure.

FIG. 2 is a schematic diagram of a system for business loyalty and reward programs according to an embodiment of the present disclosure.

FIG. 3 is a schematic diagram of a system for business loyalty and reward programs according to an embodiment of the present disclosure.

FIG. 4 is a schematic flowchart of a method for a system for business loyalty and reward programs according to an embodiment of the present disclosure.

FIG. 5 is a schematic flowchart of a method for a system for business loyalty and reward programs according to an embodiment of the present disclosure.

FIG. 6 is a is a user interface, according to an embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The presently disclosed embodiments utilize a platform that allows a user to load all their loyalty and reward programs in one place. From there, the user simply signs up/logs in their account/digital wallet online. The platform (powered by artificial intelligence) then instantly selects and processes the payment selecting the most rewarding way, out of each payment source identified in the user account, to pay for each separate transaction. In addition, in some embodiments the user has the ability to change this selection within a predetermined amount of time after purchase. The payment engine disclosed herein is an immensely valuable and helpful tool. Users can turn reward points into cash, making points earned from any loyalty program usable anywhere, including competing merchants. This is accomplished by providing a marketplace within the platform where users can exchange points in one program for points in another program, or exchange points for cash, in an auction setting or via a direct offer price.

Users of the embodiments disclosed herein will no longer be encumbered by insufficient point/reward balances caused by a lack of continuity across multiple programs because the present platform will automate the process of using them interchangeably like cash. Users will be able to substitute and interchange points, miles, and rewards, literally turning all rewards benefits into cash usable anywhere, anytime. Users will also be able to split the way they pay among different payment methods and using points.

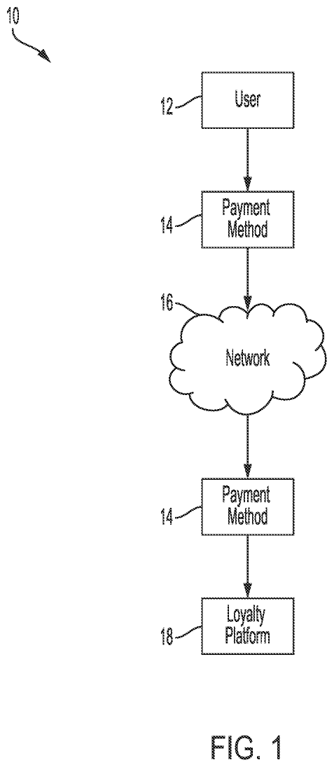

FIG. 1 is a schematic diagram of a system for business loyalty and reward programs according to an embodiment of the present disclosure. In such an embodiment, the system 10 includes a user 12, a payment method 14, a network 16 and a loyalty platform 18. The user 12 adds a payment method 14 to the loyalty platform 18 via a network 16. The payment method 14 may be a credit card, debit card, reward points from any source, loyalty points from any source, electronic currency, cryptocurrency, checking account or other tender that the user 12 owns. The network 16, according to this embodiment is a closed network or the internet. According to an embodiment, the user 12 adds only one payment method 14 to the loyalty platform 18. In another embodiment, the user 12 adds two or more payment methods 14 to the loyalty platform 18. By adding payment methods 14 to the loyalty platform 18, the user 12 may later utilize one or more of the payment methods 14 for the purchase of goods and/or services through the loyalty platform 18.

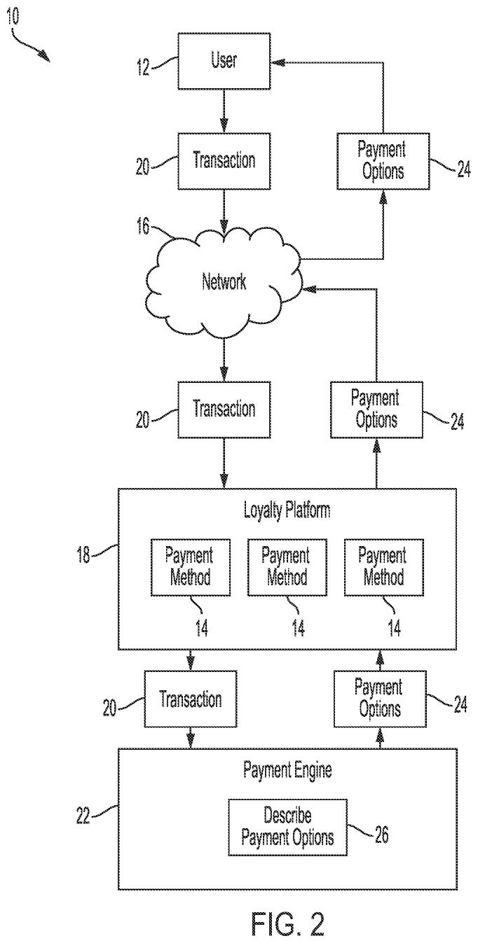

FIG. 2 is a schematic drawing of a system for business loyalty and reward programs according to an embodiment of the present disclosure. In such an embodiment, the user 12 initiates a purchase transaction which generates transaction data 20. The purchase transaction initiated by the user 12 may be at a physical point of sale (for example, a cash register and/or card reader within a bricks-and-mortar retail location) or may be a virtual point of sale (for example, a checkout page of an online retailer). The transaction data 20 may include at least a payment amount that must be tendered to the retailer to complete the purchase transaction. The transaction data 20 is submitted to the loyalty platform 18 via the network 16. In some embodiments, the transaction data 20 is submitted to the loyalty platform 18 by the point of sale terminal (for example, the cash register/card reader or the checkout page software) when the user 12 presents a virtual card associated with the their account on the loyalty platform 18 for payment. According to an embodiment, the loyalty platform 18 holds one or more payment methods 14 identified by the user 12. The loyalty platform 18 sends the transaction data 20 and the payment methods 14 to a payment engine 22. The payment engine 22 reviews all available payment methods 14 and determines the available payment options 24, including the most desirable payment option 26. The payment engine then sends the available payment options 24 to the user 12 through the loyalty platform 18 and the network 16. For example, the user 12 may receive the payment options 24 on their mobile device that is being used as the payment source (virtual card) at a physical point of sale, or on a computing device that the user is using to complete an online transaction at a virtual merchant. The user 12 is then able to make a selection from the available payment options 24.

It will be appreciated by one of skill in the art, that the payment engine 22 may be incorporated into the loyalty platform 18 in some embodiments such that the determination of available payment options 24 and the most desirable payment option 26 takes place within the loyalty platform 18.

In some embodiments, the payment engine 22 is a recommendation engine (employing artificial intelligence, machine learning models, etc.) that reviews all of the available payment methods 24 and suggests the most desirable payment option based upon predetermined criteria, such as minimizing the amount of cash that must be used, minimizing the amount of credit that must be used, maximizing the amount of loyalty points that may be redeemed to make the purchase, and/or maximizing the amount of loyalty points that may be earned while making the purchase, to name just a few non-limiting examples. In some embodiments, loyalty platform 18 and/or the payment engine 22 have the ability to use points/rewards from a loyalty program not affiliated with the current retailer to pay for the transaction. In some embodiments, the payment engine 22 may recommend that points/rewards be used to pay for a portion of the transaction amount and use cash/credit to pay the remainder. In some embodiments, the payment engine 22 may recommend that points/rewards from one program be used to pay for a portion of the transaction amount, and that points/rewards from another program be used to pay for a portion of the transaction amount. In other embodiments, the payment engine 22 may recommend that points/rewards from more than two loyalty programs be aggregated to pay the transaction amount. In some embodiments, the loyalty platform 18 may award loyalty points/rewards to the user 12 for use of the loyalty platform 18 to process the transaction. In some embodiments, the payment engine may recommend a financing facility (such as a consumer loan other than a credit card) be used to pay for the transaction (especially for larger ticket items). Leveraging the payment engine 22 with the ability to deliver a consolidated view of all of the user's enrolled payment and loyalty programs in one place, the user is relieved of the stress of determining the best way to pay within seconds at the checkout, in store or online. The payments become frictionless, smart and rewarding.

In some embodiments, the platform may include an auction model to provide micro loans: With credit cards charging between 19%-29% interest, users will be able to request offers from third party micro lenders at rates in the 8%-9% range, for example.

In some embodiments, the loyalty platform 18 includes a rewards points aggregator and point conversion service to provide users “one-click” payments using their earned points from one or more of their enrolled rewards programs. In many cases, users fail to redeem points from loyalty accounts because they have insufficient points or just do not know their point balance. The loyalty platform 18 consolidates points from all of the user's programs, shows the user the available cash equivalent and makes redemption from multiple programs frictionless and simple because points become interchangeable and convertible into cash. The payment engine 22 takes away the need to determine which program will provide what points. Additionally, users may to pay with a combination of points and cash (split tendering).

In some embodiments, the platform may include an auction-like online real-time exchange where different sources of value, fiat and non-fiat, rewards, points, vouchers and more may be traded against cash. For example: X has 50,000 Swiss Air miles but she needs American Airlines miles. Y has 70,000 American Airlines miles but he needs Swiss Air miles. The platform may publish the miles available from each party and ask for a bid. This way, X and Y can agree on an exchange of Swiss Air miles for American Airlines miles so that they now each have the miles that they need. Alternatively, X and Y may sell miles for cash and/or purchase miles for cash.

In some embodiments, the system may convert non-liquid assets to fiat currency between multiple parties. A contract will be automatically generated between the parties by the system, and custody of assets will be held in an escrow account while terms of contract are satisfied. For example, loyalty points can be converted from one party to fiat currency. The points are transferred from the initial account holder to the escrow account (maintained by the loyalty platform 18) at the start of the transaction. When both parties agree the upon the value and currency, fiat will be transferred to the receiving account. As another example, a company has accrued loyalty points in the regular course of business, and would like to convert the points to cash. Another company would like to purchase the loyalty points. Once they agree to a cash price, the cash and loyalty points are transferred to an escrow account. When both parties satisfy the terms of the agreement, the cash and points are transferred to the appropriate parties.

In some embodiments, the system maintains the approximate cash price for loyalty points of any particular type based on demand and recent transactions. Cash prices may be maintained in various currencies, such as USD, Euros, and various cryptocurrencies based on standard exchange rates. Escrow accounts can pay out cash based on any supported currency but does not convert between them. As another example, a company needs to pay monthly bills, but does not have a cash on hand. The company sells their warehouse space through the loyalty platform 18 auction market for USD, and are able to pay their bills. Both parties pay a fee to the loyalty platform 18 to participate. The fee is paid in fiat cash at the start of escrow. In some embodiments, failed transactions still must pay the fee.

In another example, a corporation has accrued rewards points in the regular course of business and would like to distribute the points to members of its staff. The points are transferred to the escrow account of the loyalty platform 18, and immediately transferred to staff accounts that are also maintained on the loyalty platform 18. in another example, a corporation is unable to collect payment from a customer, but the customer has points in multiple loyalty programs. The customer transfers an agreed upon amount of loyalty points to an escrow account on the loyalty platform 18, which are then transferred to an account of the corporation on the loyalty platform 18 in lieu of payment of fiat currency from the customer to the corporation.

In some embodiments, the loyalty platform 18 maintains a marketplace for non-liquid assets with a recommendation engine (utilizing artificial intelligence, machine learning models, etc.). Parties can enter into an agreement to exchange the assets through the loyalty platform 18 using a no-trust model. Prices for assets are based on historical values, recent transactions, and demand. For example, a company would like to sell warehouse space but does not have access to a buyer. The marketplace of the loyalty platform 18, using the recommendation engine, recommends a buyer based on profile information, past purchases, and peer groupings. The system suggests a price to the buyer and seller. Each participant can accept or override the suggestion. System facilitates the two parties to come to an agreement on price and automatically generates a contract. In other embodiments, loyalty points can be sold on the open market based on value set by the loyalty program, demand, and recent transactions. Prices are tracked by the system over time and visualized to the customers. In some embodiments, there is no fee to bid on items in the marketplace. When an item is listed for sale, a fee is collected. Fee is based on the item type, probability of being sold, and current inventory of similar items. The system recommends to a user to buy or sell the item based on their current status. For instance, if a user's loyalty program balance requires some points to be able to be redeemed, the system will suggest a purchase from another user to fill the gap.

In some embodiments, the platform may allow the use of rewards for payment in advance of the user earning the reward. For example, if a user does have not sufficient points or miles from all their programs, the platform will “top up” a user's available balance from all their programs to allow them to redeem a reward based on future behavior. The platform will not be taking credit risk, as it partitions the necessary future activity against an existing payment method (such as a credit card, to name just one non-limiting example).

In some embodiments, the payment engine 22 is designed as a data mart that uses application programming interfaces (APIs) to connect with issuing financial institutions, reward program providers and other industry source databases to maintain accurate information about individual card programs and balances as well as program rules. The collected data is then be used to evaluate the best method of payment available to an individual user based on the identified merchant. By identifying the merchant, using geolocation and geo-fencing capabilities, for example, before payment credentials are presented, the payment engine 22 requires only a 1-2 second window (the same time frame as ApplePay) to determine the best payment method and present payment credentials. However, in the background, the payment engine 22 is constantly running scenarios on behalf of the user based on the user's known location and spending patterns and habits so the payment engine 22 is always at the ready when the user presents the virtual payment card to a retailer for payment.

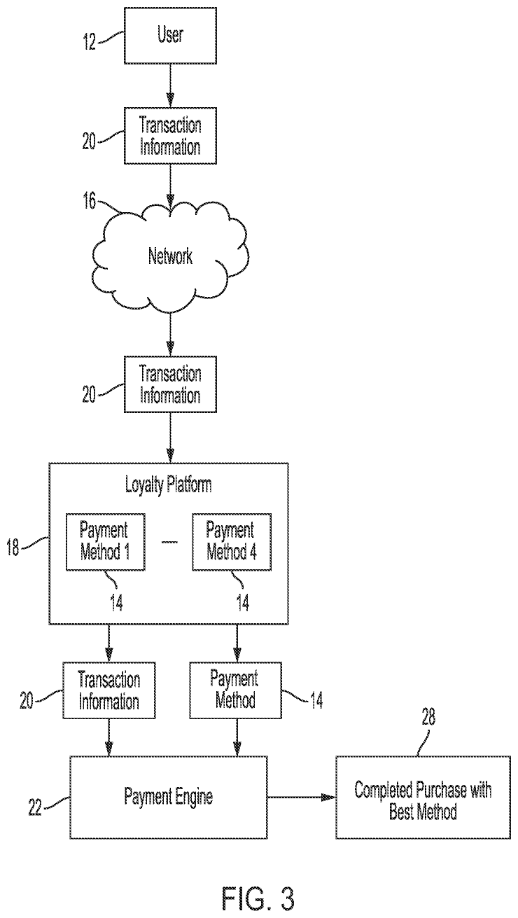

FIG. 3 is a schematic drawing of a system for business loyalty and reward programs according to an embodiment of the present disclosure. According to such an embodiment, the user 12 submits transaction data 20 to the loyalty platform 18 via the network 16. The transaction data 20 and the payment methods 14 are sent by the loyalty platform 18 to the payment engine 22. According to this embodiment, the payment engine 22 determines the most desirable payment option 26 and completes the transaction 28. According to this embodiment, the user 12 is not required to select a transaction from the payment options 24 to complete the transaction—the most desirable payment option 26 is automatically presented to the retailer as the form of payment. In some embodiments, at the point of sale, the geo-enabled payment engine 22 knows the exact merchant the user is shopping at, assesses which card or account is the best way to pay, and then passes those credentials through for payment, based on customer declared preferences and goals. One account may offer a better extended warranty, while another account may generate more rewards points. Which is best? Most users do not know, but the payment engine 22 does. The payment engine 22 is agnostic to the payment network and maintains the integrity of each transaction with a level of intelligence that is simple and secure and puts the user first.

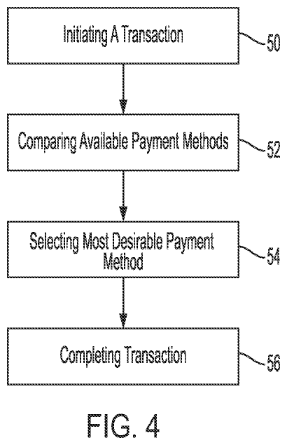

FIG. 4 is a flowchart of a method for a system for business loyalty and reward programs. According to an embodiment of the present disclosure, the method includes the steps of initiating a transaction 50, comparing available payment methods 52, and selecting the most desirable payment method 54. The transaction is then completed 56 using the selected payment method

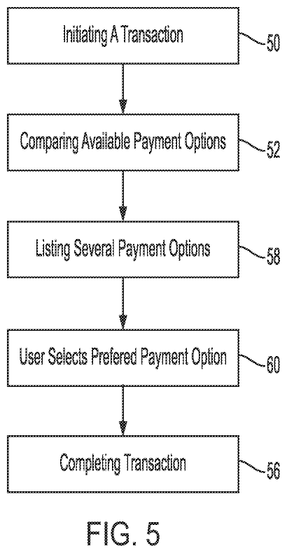

FIG. 5 is a flowchart of a method for a system for business loyalty and reward programs. According to an embodiment of the present disclosure the method involves the steps of initiating a transaction 50, comparing available payment methods 52, listing payment options 58, and allowing the user to select the desired payment option 60, wherein the desired payment option will be used to complete the transaction 56.

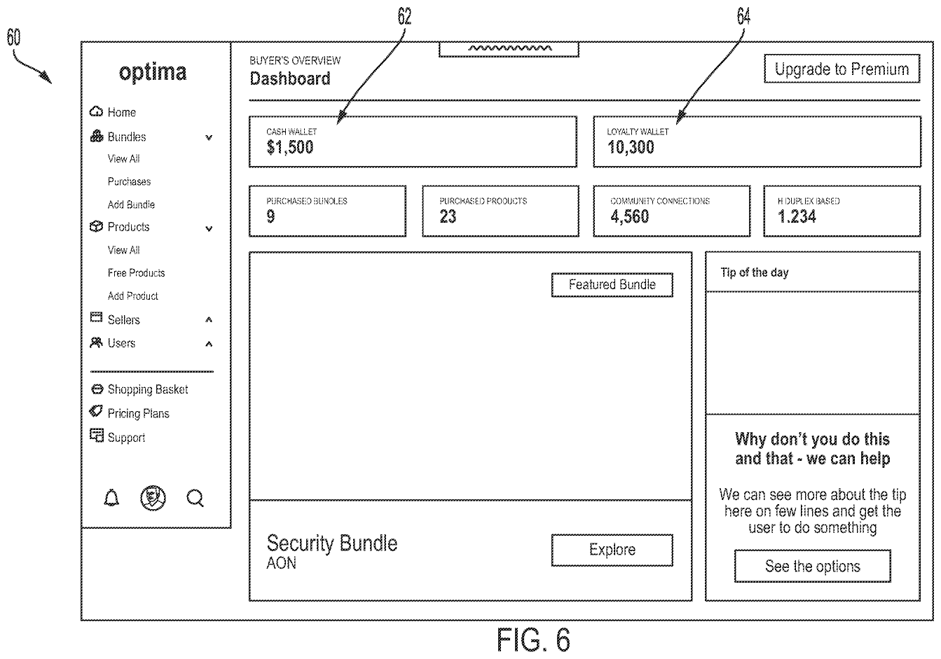

FIG. 6 is a user interface, according to an embodiment of the present disclosure. According to an embodiment, the user interface 60 includes the cash funds available in the user's account 62 and the loyalty points available 64.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. A system for business loyalty programs comprising:
a loyalty platform comprising a plurality of available payment methods; and
a payment engine configured to review the plurality of available payment methods
wherein the payment engine identifies desirable payment options from the available payment methods.

2. The system of claim 1 wherein the available payment methods include reward points, credit cards, debit cards, or other sources of tender.

3. The system of claim 1 wherein the payment engine utilizes customer data in order determine the most desirable payment options.

4. The system of claim 1 wherein the payment engine converts one of the available payment methods into another available payment method in order to create a desirable payment option.

5. The system of claim 1 wherein the most desirable payment option comprises only one available payment method.

6. The system of claim 1 wherein the most desirable payment option comprises two or more available payment methods.

7. The system of claim 1 wherein the payment engine selects the most desirable payment option.

8. The system of claim 7 wherein the payment engine provides several alternative payment options in addition to the most desirable payment option.

9. The system of claim 1 wherein the payment engine

10. A method of administering business loyalty programs comprising:
initiating a transaction;
comparing a plurality of available payment methods;
displaying the available payment options; and
completing the transaction with one of the available payment options.

11. The method of claim 7 wherein the available payment methods include reward points, credit cards, debit cards, or other sources of tender.

12. The method of claim 7 wherein the payment engine utilizes customer data in order determine the most desirable payment option.

13. The method of claim 7 wherein the payment engine converts one of the available payment methods into another available payment method.

14. The method of claim 7 wherein the most desirable payment option comprises only one available payment method.

15. The method of claim 7 wherein the most desirable payment option comprises two or more available payment methods.

16. The method of claim 7 wherein the payment engine provides several alternative payment options in addition to the most desirable payment option.
